(19) United States
(12) Patent Application Publication
(10) Pub. No.: US 2018/0167615 A1
(43) Pub. Date: Jun. 14, 2018

(54) SYSTEMS AND METHODS FOR OPTIMIZING VIDEO CODING BASED ON A LUMINANCE TRANSFER FUNCTION OR VIDEO COLOR COMPONENT VALUES

(71) Applicant: Sharp Kabushiki Kaisha, Sakai City, Osaka (JP)

(72) Inventors: Seung-Hwan KIM, Camas, WA (US); Jie ZHAO, Camas, WA (US); Christopher Andrew SEGALL, Camas, WA (US); Kiran Mukesh MISRA, Camas, WA (US)

(21) Appl. No.: 15/579,850

(22) PCT Filed: Jun. 7, 2016
(86) PCT No.: PCT/JP2016/002761

§ 371 Date: Dec. 5, 2017

Related U.S. Application Data
(60) Provisional application No. 62/172,177, filed on Jun. 7, 2015.
(60) Provisional application No. 62/233,352, filed on Sep. 26, 2015.

(51) Int. Cl. H04N 19/124; H04N 19/186; H04N 19/18; H04N 19/184

(52) U.S. Cl. CPC H04N 19/124; H04N 19/184; H04N 19/18; H04N 19/186

(57) ABSTRACT

A video coding device may be configured to receive receiving video data generated based on a range mapping error. A range mapping error may result from a luminance transfer function corresponding to High Dynamic Range (HDR) video data being using to transform video data that is not HDR. The video coding device may be configured to mitigate the range mapping error. The video coding device may remap video data. The video coding device may perform coding techniques that mitigate that the remapping error.

### TECHNICAL FIELD

This disclosure relates to video coding and more particularly to techniques for optimizing video coding based on a luminance transfer function or video color component values.

### BACKGROUND ART

Digital video capabilities can be incorporated into a wide range of devices, including digital televisions, including so-called smart televisions, laptop or desktop computers, tablet computers, digital recording devices, digital media players, video gaming devices, cellular telephones, including so-called “smart” phones, medical imaging devices, and the like. Digital video may be coded according to a video coding standard. Examples of video coding standards include ISO/IEC MPEG-4 Visual and ITU-T H.264 (also known as ISO/IEC MPEG-4 AVC) and High-Efficiency Video Coding (HEVC), ITU-T H.265 and ISO/IEC 23008-2 MPEG-H. Extensions and improvements for HEVC are currently being developed. For example, the Video Coding Experts Group (VCEG) designates certain topics as Key Technical Areas (KTA) for further investigation. Techniques developed in response to KTA investigations may be included in future video coding standards, (e.g., “H.266”). Video coding standards may incorporate video compression techniques.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (or macroblocks) within a slice, coding blocks within a coding tree unit, coding units within a coding block, etc.). Spatial techniques (i.e., intra-frame coding) and/or temporal techniques (i.e., inter-frame coding) may be used to generate a difference value between a coding unit to be coded and a reference coding unit. The difference value may be referred to as residual data. Residual data may be coded as quantized transform coefficients. Syntax elements (e.g., reference picture index, motion vectors and block vectors) may relate residual data and a reference coding unit. Residual data and syntax elements may be entropy coded.

Video coding standards specify formats of video data that are supported for coding. For example, the Main 10 profile of HEVC specifies that video data having a 4:2:0 chroma sampling format and a bit depth of eight or ten bits for each video component is supported. A digital video camera initially generates raw data corresponding to signals generated by each of its image sensors. For example, raw data may include absolute linear luminance level values for each of a red, green, and blue channel. An optical-electro transfer function (OETF) may map absolute linear luminance values to digital code words in a non-linear manner. The resulting digital code words may be converted into video format supported by a video coding standard. The conversion of raw data, e.g., linear luminance levels, into a format supported by a video coding standard typically results in data loss. In some cases, this data loss may result in non-optimal coding. In other example, the Main 10 profile of HEVC specifies that video data having a 4:2:0 chroma sampling format and a bit depth of eight or ten bits for each video color component is supported. Further, HEVC specifies video usability information (VUI) which may be used to signal one of a plurality of possible color spaces for video data by signaling color primaries. Color primaries may include chromaticity coordinates for a primary green value, a primary blue value, a primary red value, and a reference white value (e.g., white D65). Chromaticity coordinates may be specified in terms of a reference color gamut, e.g., the International Commission on Illumination (CIE) 1931 color gamut. Current video coding techniques may be less than ideal for coding video data having certain color spaces.

### SUMMARY OF INVENTION

### Technical Problem

In general, this disclosure describes various techniques for predictive video coding. In particular, this disclosure describes techniques for optimizing video coding according to a defined or expected luminance transfer function. As used herein the term luminance transfer function may refer to an optical-electro transfer function (OETF) or an electro-optical transfer function (EOTF). It should be noted that an optical-electro transfer function may be referred to as an inverse electro-optical transfer function and an electro-optical transfer function may be referred to as an inverse optical-electro transfer function (even if the two transfer functions are not exact inverses of each other). The techniques for optimizing video coding also based on video color component values. It should be noted that as used herein the term color gamut may typically refer to an entire range of colors available to a particular device (e.g., a television) and a color space may refer to range of color data values within a color gamut. It should be noted however, that in some cases the terms color gamut and color space may be used interchangeably. As such, particular uses of the term color space or color gamut with respect to the techniques described herein should not be construed as limiting the scope of the techniques described herein. The techniques described herein may be used to compensate for non-optimal video coding performance that occurs when the mapping of luminance values to digital code words is less than ideal. For example, in practice an OETF may map a range of luminance values to less than all (e.g., approximately half) of the available digital code words for a given bit-depth. In this case, a video encoder designed based on an assumption that all of the available digital code words for a bit-depth correspond to the entire range of luminance values would typically not perform video coding in an optimal manner. The techniques described herein also may be used to compensate for non-optimal video coding performance that occurs when video data includes a larger than anticipated color space and/or a larger than anticipated dynamic range. For example, a video encoder and/or a video coding standard may have been designed based on an assumption that video data would generally be limited to video data having a color space defined according to the ITU-R BT.709 standard and a so-called standard dynamic range (SDR). Current display technology may support the display of video data having a color space with a greater range (i.e., larger area) than ITU-R BT.709 (e.g., a color space defined according to the ITU-R BT 2020 standard) and having a so-called high dynamic range (HDR). Further, next generation video displays may support further improvement in dynamic range and color space capabilities. Examples of color spaces with a range greater than ITU-R BT.709 include ITU-R BT.2020 (Rec. 2020) and DCI-P3 (SMPTE PR 431-2). It should be noted that although the techniques described herein are described with respect to particular color spaces in some example, the techniques described herein are not limited to a particular color space. Further, it should be noted that although techniques of this disclosure, in some examples, are described with respect to the ITU-T H.264 standard and the ITU-T H.265 standard, the techniques of this disclosure are generally applicable to any video coding standard, including video coding standards currently under development (e.g., “H.266”).

### Solution to Problem

In one example, a method of modifying video data comprises receiving video data, determining a remapping parameter associated with the video data, and modifying values included in the video data based at least in part on the remapping parameter.

In one example, a device for modifying video data comprises one or more processors configured to receive video data, determine a remapping parameter associated with the video data, and modify values included in the video data based at least in part on the remapping parameter.

In one example, a non-transitory computer-readable storage medium comprises instructions stored thereon that, when executed, cause one or more processors of a device for coding video data to receive video data, determine a remapping parameter associated with the video data, and modify values included in the video data based at least in part on the remapping parameter.

In one example, an apparatus for modifying video data comprises means for receiving video data, means for determining a remapping parameter associated with the video data, and means for modifying values included in the video data based at least in part on the remapping parameter.

In one example, a method of coding video data comprises receiving video data, determining a utilized range of values for the video data, and determining one or more coding parameters based on the utilized range of values for the video data.

In one example, a device for coding video data comprises one or more processors configured to receive video data, determine a utilized range of values for the video data, and determine one or more coding parameters based on the utilized range of values for the video data.

In one example, a non-transitory computer-readable storage medium comprises instructions stored thereon that, when executed, cause one or more processors of a device for coding video data to receive video data, determine a utilized range of values for the video data, and determine one or more coding parameters based on the utilized range of values for the video data.

In one example, an apparatus for coding video data comprises means for receiving video data, means for determining a utilized range of values for the video data, and means for determining one or more coding parameters based on the utilized range of values for the video data.

In one example, a method of determining a quantization parameter comprises receiving an array of sample values corresponding to a component of video data, determining an average value for the array of sample values, and determining a quantization parameter for an array of transform coefficients based at least in part on the average value.

In one example, a device for determining a quantization parameter comprises one or more processors configured to receive an array of sample values corresponding to a component of video data, determine an average value for the array of sample values, and determine a quantization parameter for an array of transform coefficients based at least in part on the average value.

In one example, a non-transitory computer-readable storage medium comprises instructions stored thereon that, when executed, cause one or more processors of a device for coding video data to receive an array of sample values corresponding to a component of video data, determine an average value for the array of sample values, and determine a quantization parameter for an array of transform coefficients based at least in part on the average value.

In one example, an apparatus for modifying video data comprises means for receiving an array of sample values corresponding to a component of video data, means for determining an average value for the array of sample values, and means for determining a quantization parameter for an array of transform coefficients based at least in part on the average value.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may be configured to encode and decode video data according to one or more techniques of this this disclosure.

FIG. 2 is a block diagram illustrating an example of a video processing unit configured to process video data according to one or more techniques of this disclosure.

FIG. 3 is a block diagram illustrating an example of a video processing unit configured to process video data according to one or more techniques of this disclosure.

FIG. 4 is a block diagram illustrating an example of a video encoder that may be configured to encode video data according to one or more techniques of this disclosure.

FIG. 5 is a block diagram illustrating an example of a video decoder that may be configured to decode video data according to one or more techniques of this disclosure.

FIG. 6 is a conceptual diagram illustrating two neighboring video blocks.

### DESCRIPTION OF EMBODIMENTS

Digital image capturing devices and digital image rendering devices may have a specified dynamic range. A dynamic range may refer to a range (or ratio) of a maximum luminance capability of a device to a minimum luminance capability of a device. For example, a television may be capable of producing a black level luminance of 0.5 candelas per square meter (cd/m² or nits) and a peak white luminance of 400 cd/m² and thus may be described as having a dynamic range of 800. In a similar manner, the black level luminance value that a video camera is capable of sensing may be 0.001 cd/m² and the peak white luminance value that the camera is capable of sensing may be 10,000 cd/m². Dynamic ranges may be classified as either being a high dynamic range (HDR) or a low or standard dynamic range (SDR). Typically, a dynamic range no greater than 100 to 500 is classified as a SDR and a dynamic range greater than a SDR is classified as a HDR. In one example, SDR content may be based on Recommendation ITU-R BT.1886, reference electro-optical transfer function for flat panel displays used in HDTV studio production. It should be noted that in some cases HDR is more specifically defined as having a luminance range of 0 to 10,000 cd/m².

In one example, HDR content may be described with respect to ST 2084:2014 High Dynamic Range Electro-Optical Transfer Function of Mastering Reference Displays published by the Society of Motion Picture and Television Engineers (SMPTE). In a similar manner, digital image capturing devices and digital image rendering devices may have a specified color gamut. In this instance, a color gamut may refer to a physical capabilities of a device. For example, a digital image capturing device may be capable of recording video within the ITU-R BT.2020 color space. Traditionally, video systems have been designed based on an assumption that video content would ultimately be rendered on a display device with ITU-R BT.709 color space capabilities. For example, traditional television systems were designed based on an assumption that video content would be rendered on cathode ray tube (CRT) displays having a dynamic ranges of around 100. As such, although some components used within a traditional video system may have supported HDR video data capabilities such capabilities were not utilized. Current experimental and commercially available video capturing devices and video rendering devices support HDR video data. As such, there is motivation to design video systems to support the capturing, encoding, transmission, decoding, and/or rendering of HDR video data. In some instances it may be difficult and/or cost prohibitive for a video system to include distinct components for supporting SDR video data and to include distinct components supporting HDR video data. The example techniques described herein may enable a video system to more efficiently support both SDR video and HDR video. Video data may be described as being stored within a container where a container specifies a dynamic range and a color space. For example, video data may be described as being stored within a BT.2020/ST-2084 container.

Digital image capturing devices record an image as a set of linearly related luminance values (e.g., a sensed luminance value for each sensor within an array). Likewise, digital image rendering devices render images based on a set of linearly related electrical values (e.g., a voltage provided to each physical pixel composing a display). Human vision does not perceive changes in luminance values in a linear manner. That is, for example, an area of an image associated with a luminance value of 100 cd/m² is not necessarily perceived as twice as bright an area of an image associated with a luminance value of 200 cd/m². As such, a luminance transfer function (e.g., an optical-electro transfer function (OETF) or an electro-optical transfer function (EOTF)) may be used to convert linear luminance data into data that can be perceived in a meaningful way.

An OETF may map linear luminance values to a non-linear perceptual function, where a non-linear perceptual function is based on characteristics of human vision. A non-linear perceptual function may be characterized by a perceptual curve. An OETF may be used to map luminance values captured by a digital image capturing device to a perceptual function. An OETF may normalize a range of linear luminance values (e.g., normalize 0-10,000 cd/m² to 0-1) and map the normalized values to values of a defined perceptual curve. Mapping the normalized values to values of a defined perceptual curve may be referred to as non-linear encoding. Further, the normalized values may be mapped to digital code words, i.e., after scaling, if necessary. These processes enable quantized perceptual curve values to be mapped to binary values (e.g., map perceptual curve values to 2¹⁰ code words). For example, an OETF may receive luminance values from a video camera, which may be referred to as raw video data or minimally processed video data, as input and a set of a 12-bit values for each of a red, green, and blue channel in an RGB color space may be generated after scaling and quantiztion. The values generated by an OETF may correspond to a defined image/video format. It should be noted that in some examples, these defined image/video formats may be described as uncompressed image/video data.

Uncompressed video data may be compressed according to a video coding standard, e.g., using spatial and/or temporal techniques. However, prior to compression, digital values generated using an OETF and source video data (e.g., video data generated by a video capturing device) are typically required to be converted into a video format supported by a video coding device. A video format supported by a video coding device includes a video format that a video encoder can receive and encode into a compliant bitstream and/or a video format that is output by a video decoder as the result of decoding a compliant bitstream. Converting digital values generated using an OETF and source video data into a video format supported by a video coding device may include color space conversion, quantization, and/or down sampling. For example, a video coding standard may support coding of video data having a 4:2:0 chroma sampling format and a bit depth of 10 bits for each video color component and video data generated by an OETF and a video capturing device may include 12-bit RGB values. In this example, a color space conversion technique may be used to convert the 12-bit RGB values into corresponding values in a YCbCr color space (i.e., a luma (Y) channel value and chroma (Cb and Cr) channel values). Further, a quantization technique may be used to quantize the YCbCr color space values to 10 bits. Finally, a down sampling technique may be used to down sample the YCbCr values from a 4:4:4/sampling format to a 4:2:0 sampling format. In this manner, luminance values recorded by a video capturing device may be converted to a format supported by a video coding device. It should be noted that each of an OETF transformation, quantization, and down sampling may result in data loss.

It should be noted that although video coding standards may code video data independent of luminance transfer functions (i.e., luminance transfer functions are typically outside the scope of a video coding standard), the expected performance of a video coding standard may be based on expected values of data within a supported video coding format and anticipated supported video coding formats and the expected values of data within a supported video coding format may be based on assumptions with respect to luminance transfer functions. That is, for example, a video coding standard may be based on an assumption that particular code words generally correspond to particular minimum and maximum luminance values and the majority of video data transmitted using a video system will have a specific supported format (e.g., 75% of video data will be based on a ITU-R BT.709 color space) and the majority of sample values will be within a certain range of the supported video coding format. This may result in less than ideal coding when video data does not have values within the expected ranges, particularly, when video data has a greater than expected range of values. It should be noted that less than ideal video coding may occur within a frame of data. For example, for a 10-bit video channel data, a video coding standard may be based on the assumption that the minimum code word value (e.g., 0) generally corresponds to a luminance level of 0.02 cd/m2 and the maximum code word value (e.g., 1023) generally corresponds to a luminance level of 100 cd/m2. This example may be described as mapping SDR video data (e.g., data ranging from 0.02 cd/m2 to 100 cd/m2) to 10-bit code words. In other example, one region of a frame may include a portion of a scene in a shadow and as such, may have a relatively smaller dynamic range than a portion of a scene not in a shadow. The techniques described herein may be used to optimize video coding by varying coding parameters based on video color component values, e.g., luminance values.

As described above, based on the current capabilities of video rendering devices there is motivation for video systems to support coding of HDR video data. As further described above, it may be impractical for a video system to include independent components for each of SDR video data and HDR video data. In some cases, it may be difficult, impractical, and/or cost prohibitive to implement multiple luminance transfer functions within a video system. As described in detail below, transforming SDR data using a luminance transform functions corresponding to HDR data may result in non-optimal coding.

Examples of luminance transform functions corresponding to HDR data include the so-called SMPTE (Society of Motion Picture and Television) High Dynamic Range (HDR) Transfer Functions, which may be referred to as SMPTE ST 2084. The SMPTE HDR Transfer Functions include an EOTF and an inverse-EOTF. The SMPTE ST 2084 inverse-EOTF is described in HEVC according to the following set of equations:

L_{c}=C/10,000

V=((c₁+c₂*L_{c}ⁿ)/(1+c₃*L_{c}ⁿ))^{m}
c1=c3−c2+1=3424/4096=0.8359375
c2=32*2413/4096=18.8515625
c3=32*2392/4096=18.6875
m=128*2523/4096=78.84375
n=0.25*2610/4096=0.1593017578125
where / is real-valued division

The corresponding SMPTE ST 2084 EOTF may be described according to the following set of equations:

L_{c}=((max[(V^{1/m}−c₁),0])/(c₂−c₃*V^{1/m}))^{1/n}

C=10,000*L_{c}

In the equations above, C is a luminance value with an expected range of 0 to 10,000 cd/m². That is, equal to 1 is ordinarily intended to correspond to a luminance level of 10,000 cd/m². C may be referred to as an optical output value or an absolute linear luminance value. Further, in the equations above, V may be referred to as a non-linear color (or luminance) value or a perceptual curve value. As described above, an OETF may map perceptual curve values to digital code words. That is, V may be mapped to 2^{N} bit code words. An example of a function that may be used to map V to 10-bit code words may be defined as:

Digital Value=INT(1023*V),
where INT(x) generates an integer by rounding down for fractional values less than 0.5 and rounding up for fractional values greater than or equal to 0.5.

It should be noted that in other examples, a function used to map V to N-bit code words may map the range of values of V to less than 2^{N} code words (e.g., code words may be reserved). Table 1 provides an example of code words generated for approximate input values of C.

TABLE 1

| C (cd/m²) | Digital Value |
|---|---|
| ~0.56 | 128 |
| ~5 | 256 |
| ~92 | 512 |
| ~313 | 640 |

As illustrated in Table 1, half of the 1024 available code words quantize the approximate luminance range of 0 to 92 cd/m² and half of the 1024 code words quantize the approximate luminance range of 92 to 10,000 cd/m². Thus, if SMPTE ST 2084 is used to quantize SDR video data, approximately half of the available code words are unused, e.g., max value of SDR video data of 100 cd/m² may be quantized as 520. This may result in non-optimal performance of a video coder, including a video coder implementing aspects of HEVC. For example, and as described in greater detail below, techniques in HEVC that are based on bit-depth and/or quantization parameter values may not perform optimally if a range of sample values does not occupy most (e.g., at least half) of the range of 0 to 2^{N} code words or an expected range. Examples of such techniques include deblock filtering, sample adaptive offset (SAO) filtering, quantization parameter derivation, interpolation (e.g., used within motion compensation), and initialization of unavailable samples. The term range mapping error, as used herein, may refer to cases where sample values occupy a range of code words in a non-ideal or unexpected way and may include clipping (e.g., mapping a maximum sample value to code word value less than the maximum code word value), overpopulation of a sub-range (e.g., mapping a large range of sample values to a small range of code words), and/or under population of a sub-range (e.g., mapping a small range of sample values to a large range of code words). The techniques described herein may be used to mitigate the effects of range mapping errors.

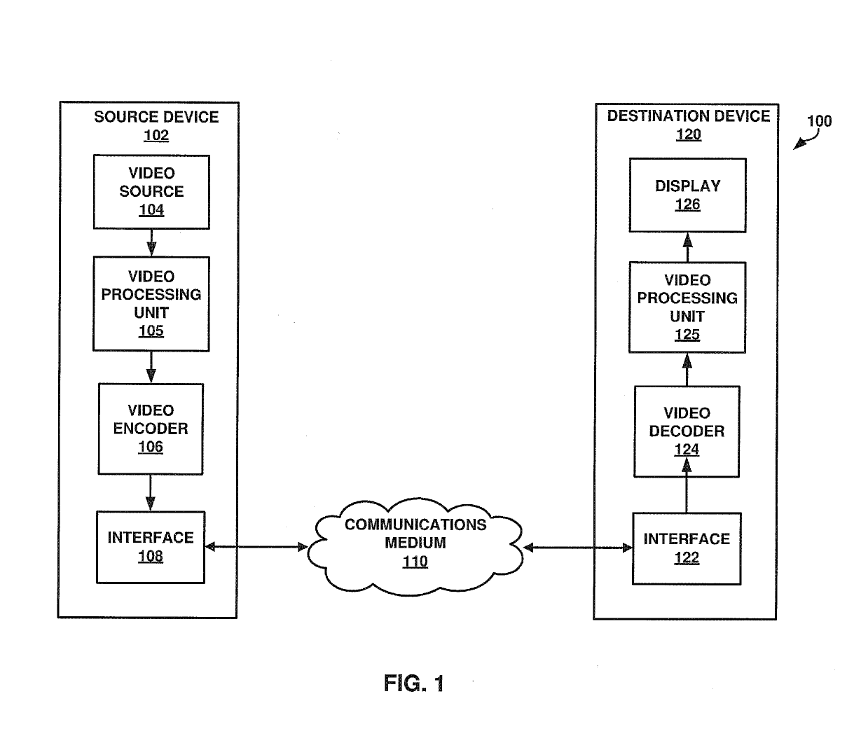

FIG. 1 is a block diagram illustrating an example of a system that may be configured to process and code (i.e., encode and/or decode) video data according to one or more techniques of this disclosure. System 100 represents an example of a system that may optimize video coding based on a luminance transfer function or video color component values according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, and/or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards.

Storage devices may include any type of device or storage medium capable of storing data. A storage medium may include tangible or non-transitory computer-readable media. A computer readable medium may include optical discs, flash memory, magnetic memory, and/or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal hard disk drive, external hard disk drives, internal solid state drives and/or external solid state drives. Data may be stored on a storage device according to a defined file format, such as, for example, a standardized media file format defined by ISO.

Referring again to FIG. 1, source device 102 includes video source 104, video processing unit 105, video encoder 106, and interface 108. Video source 104 may include any device configured to capture and/or store video data. For example, video source 104 may include a video camera and a storage device operably coupled thereto. In one example, video source 104 may include a video capturing device capable of supporting HDR video data (e.g., a device having a dynamic range of 0-10,000 cd/m²). Video processing unit 105 may be configured to receive video data from video source and convert received video data into a format that is supported by video encoder 106, e.g., a format that can be encoded.

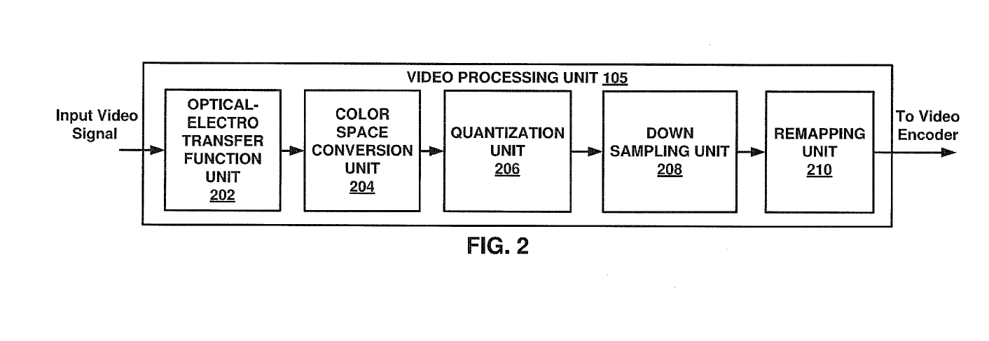

An example of a video processing unit is illustrated in FIG. 2. In the example illustrated in FIG. 2 video processing unit 105 includes optical-electro transfer function unit 202, color space conversion unit 204, quantization unit 206, down sampling unit 208, and remapping unit 210. It should be noted that although the components of video processing unit 105 may be located at various physical locations in a video system. For example, functions of optical-electro transfer function unit 202 may be performed at a production facility and functions of down sampling unit 208 may be independently performed at a broadcast facility. It should also be noted that although functions are described in a particular order below, this does not limit that performance of particular operations to a single sequence. For example, functions performed by down sampling unit 208 may be performed before functions performed by quantization unit 206. Further, it should be noted that functions performed by components of video processing unit may be performed by a source device and/or a video encoder. For example, functions performed by remapping unit 210 may be performed by video encoder 106.

Optical-electro transfer function unit 202 may be configured to receive raw or minimally processed video data and transform the video data according to another OETF. In one example, optical-electro transfer function unit 202 may be configured to transform video data according to the SMPTE ST 2084 transfer functions described above. Color space conversion unit 204 may be configured to convert video data in one color space format to video data in another color space format. For example, color space conversion unit may be configured to convert video data in an RGB color space format to video data in a YCbCr color space format according to a defined set of conversion equations. Quantization unit 206 may be configured to quantize color space values. For example, quantization unit 206 may be configured to quantize 12-bit Y, Cb, and Cr values to 8 or 10-bit values. Down sampling unit 208 may be configured to reduce the number of samples values within a defined region. For example, for an array of samples there may be a value of Y, Cb, and Cr for each pixel (i.e., 4:4:4 sampling), down sampling unit 208 may be configured to down sample the array such that for every four Y values there is a corresponding Cb and Cr value (e.g., 4:2:0 sampling). In this manner, down sampling unit 208 may output video data to a video encoder in a supported format.

As described above, when SDR video data is transformed according to OETF corresponding to HDR, e.g., a SMPTE ST 2084, a range mapping error may occur. Remapping unit 210 may be configured to detect and mitigate range mapping errors. As described above, in the case where SMPTE ST 2084 is used to quantize SDR video data, approximately half of the available code words are unused. In one example, remapping unit 210 may be configured to extend the range of code words that are used (e.g., map 100 cd/m² to bit word 1023). Remapping unit 210 may remap data based on a functional relationship between an input value, X, and a remapped value Y. A functional relationship may include combination of functions (e.g., Y=F(x)) and look-up tables. Further, respective functions and/or look-up tables may be specified for particular ranges or regions of input values. For example, input value range 0-255 may specify values of Y according to a look-up table and input value range 256-520 may specify values of Y according to a function.

In one example, a remapping function may be a linear remapping function. An example of a linear remapping function may be defined by the following set of equations:

Y=R(X)=A*X+C
where
A=(Max_R−Min_R)/(Max_I−Min_I)
C=Min_R−A*Min_I

In this example, Min_I may correspond to a minimum input value (e.g., 4), Max_I may correspond to a maximum input value (e.g., 520), Min_R may correspond to a minimum remapped value (e.g., 2), Max_R may correspond to a maximum remapped value (e.g., 1023). Each of Min_I, Max_I, Min_R, Max_R, A, and C may be referred to as remapping parameters. It should be noted that there may be other types of remapping parameters (e.g., look-tables, index values, constant values, etc.) various ways to define various types of remapping parameters. For example, a dynamic range of input data remapping parameter, DR_I, may be defined as a maximum input value minus a minimum input value. A video encoder may encode remapped data in a more efficient manner than non-remapped data. For example, color banding may be less likely to occur if data is remapped prior to being encoded by a video encoder.

As described above, in some examples, functions performed by remapping unit 210 may be implemented as part of a video encoder. In this case, a video encoder may be configured to signal remapping parameters. For example, remapping parameters and/or look-up tables may be signaled in a slice header, a picture parameter set (PPS), or sequence parameter set (SPS). As described in detail below, remapping unit 302 may be configured to perform remapping based on signaled remapping parameters. In this manner, remapping unit 210 represents an example of a device configured to receive video data, determine a remapping parameter associated with the video data, and modify values included in the video data based at least in part on the remapping parameter.

Referring again to FIG. 1, video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard, such as, for example ITU-T H.265 (HEVC), which is described in Rec. ITU-T H.265 v2 (October 2014), which is incorporated by reference in its entirety, and/or extensions thereof. Further, a compliant bitstream may be defined according to a video coding standard currently under development. When generating a compliant bitstream video encoder 106 may compress video data. Compression may be lossy (discernible or indiscernible) or lossless.

Video content typically includes video sequences comprised of a series of frames. A series of frames may also be referred to as a group of pictures (GOP). Each video frame or picture may include a plurality of slices, where a slice includes a plurality of video blocks, and a video block includes an array of pixel values. In one example, a video block may be defined as the largest array of pixel values (also referred to as samples) that may be predictively coded. As described above, sample values may be described with respect to a reference color space. For example, for each pixel, samples values may specify a green value with respect to a primary green value, a blue value with respect to a primary blue value, and a red value with respect to a primary red value. Sample values may also be specified according to other types of color spaces, for example, a pixel value may be specified using a luma color component value and two chroma color component values. As used herein, the term video block may refer at least to the largest array of pixel values that may be predictively coded, sub-divisions thereof, and/or corresponding structures. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples.

In ITU-T H.265 the CTBs of a CTU may be partitioned into Coding Blocks (CB) according to a corresponding quadtree data structure. According to ITU-T H.265 one luma CB together with two corresponding chroma CBs and associated syntax elements is referred to as a coding unit (CU). A CU is associated with a prediction unit (PU) structure defining one or more prediction units (PU) for the CU, where a PU is associated with corresponding reference samples. For example, a PU of a CU may be an array of samples coded according to an intra-prediction mode. Specific intra-prediction mode data (e.g., intra-prediction syntax elements) may associate the PU with corresponding reference samples. In ITU-T H.265 a PU may include luma and chroma prediction blocks (PBs) where square PBs are supported for intra-picture prediction and rectangular PBs are supported for inter-picture prediction. The difference between sample values included in a PU and associated reference samples may be referred to as residual data.

Residual data may include respective arrays of difference values corresponding to each component of video data. For example difference values may respectively correspond to a luma (Y) component, a first chroma component (Cb) and a second chroma component (Cr). Residual data may be in the pixel domain. A transform, such as, a discrete cosine transform (DCT), a discrete sine transform (DST), an integer transform, a wavelet transform, lapped transform or a conceptually similar transform, may be applied to pixel difference values to generate transform coefficients. It should be noted that in some examples (e.g., ITU-T H.265) PUs may be further sub-divided into Transform Units (TUs). That is, an array of pixel difference values may be sub-divided for purposes of generating transform coefficients (e.g., four 8×8 transforms may be applied to a 16×16 array of residual values), such sub-divisions may be referred to as Transform Blocks (TBs). Transform coefficients may be quantized according to a quantization parameter (QP). Quantized transform coefficients may be entropy coded according to an entropy encoding technique (e.g., content adaptive variable length coding (CAVLC), context adaptive binary arithmetic coding (CABAC), or probability interval partitioning entropy coding (PIPE)). Further, syntax elements, such as, a syntax element defining a prediction mode, may also be entropy coded. Entropy encoded quantized transform coefficients and corresponding entropy encoded syntax elements may form a compliant bitstream that can be used to reproduce video data.

As described above, prediction syntax elements may associate a video block and PUs thereof with corresponding reference samples. For example, for intra-prediction coding an intra-prediction mode may specify the location of reference samples. In ITU-T H.265, possible intra-prediction modes for a luma component include a planar prediction mode (predMode: 0), a DC prediction (predMode: 1), and 33 angular prediction modes (predMode: 2-34). One or more syntax elements may identify one of the 35 intra-prediction modes. For inter-prediction coding, a motion vector (MV) identifies reference samples in a picture other than the picture of a video block to be coded and thereby exploits temporal redundancy in video. For example, a current video block may be predicted from a reference block located in a previously coded frame and a motion vector may be used to indicate the location of the reference block. A motion vector and associated data may describe, for example, a horizontal component of the motion vector, a vertical component of the motion vector, a resolution for the motion vector (e.g., one-quarter pixel precision), a prediction direction and/or a reference picture index value. Further, a coding standard, such as, for example ITU-T H.265, may support motion vector prediction. Motion vector prediction enables a motion vector to be specified using motion vectors of neighboring blocks.

Referring again to FIG. 1, interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting PCI and PCIe bus protocols, proprietary bus protocols, Universal Serial Bus (USB) protocols, I²C, or any other logical and physical structure that may be used to interconnect peer devices.

As illustrated in FIG. 1, destination device 120 includes interface 122, video decoder 124, video processing unit 125, and display 126. Interface 122 may include any device configured to receive a compliant video bitstream from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, Universal Serial Bus (USB) protocols, I² C, or any other logical and physical structure that may be used to interconnect peer devices. Video decoder 124 may include any device configured to receive a compliant bitstream and/or acceptable variations thereof and reproduce video data therefrom.

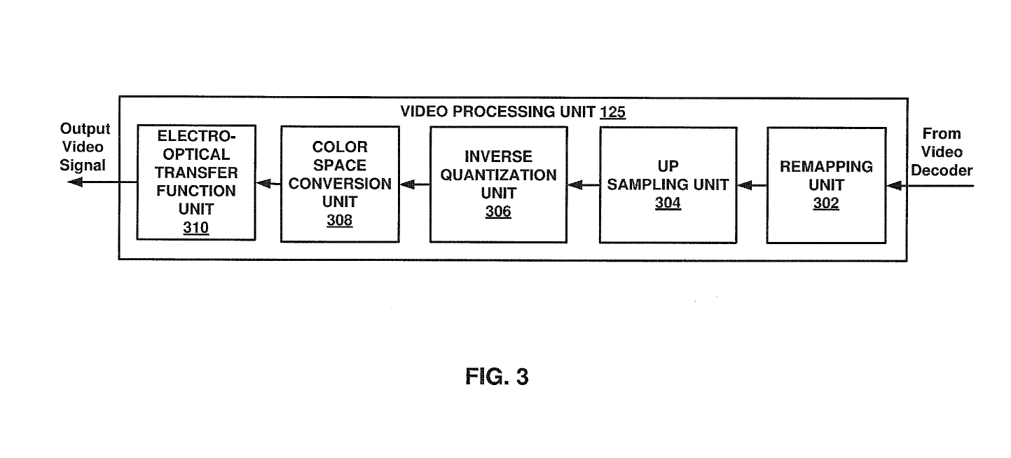

Video processing unit 125 may be configured to receive video data and convert received video data into a format that is supported by display, e.g., a format that can be rendered. An example of video processing unit 125 is illustrated in FIG. 3. In the example illustrated in FIG. 3, video processing unit 125 includes remapping unit 302, up sampling unit 304, inverse quantization unit 306, color space conversion unit 308, and electro-optical transfer function unit 310. It should be noted that function performed by components of video processing unit 125 may be performed by a video decoder and/or a display. For example, functions performed by remapping unit 302 may be performed by video decoder 124.

As described above, when SDR video data is transformed according to an OETF corresponding to HDR, e.g., a SMPTE ST 2084, a range mapping error map occur. Remapping unit 302 may be configured to detect and mitigate range mapping errors. Remapping unit 302 may be configured to detect and mitigate range mapping errors in a manner similar to that described above with respect to remapping unit 210, i.e., using a linear remapping function defined by a set of remapping parameters and/or using look-tables. It should be noted that remapping unit 302 may operate in combination with or independent of remapping unit 210. For example, as described above, a video encoder 210 may be configured to signal remapping parameters, e.g., in a slice header or picture parameter set (PPS) or sequence parameter set (SPS). In this example, remapping unit 302 may receive remapping parameter and/or look-up tables and perform remapping based on the received remapping parameters and/or look-up tables. It should be noted that in other examples, remapping unit 302 may be configured to infer remapping parameters. For example, Min_I may be inferred based on decoded video data, e.g., Min_I may be inferred as the minimum value in a set of N decoded video sample values. In this manner remapping unit 302 represents an example of a device configured to receive video data generated based on a range mapping error, determine a remapping parameter associated with the video data, and modify values included in the video data based at least in part on the remapping parameter.

Referring again to FIG. 3, up sampling unit 304 may be configured to increase the number of samples values within a defined region. For example, up sampling unit 304 may be configured to convert 4:2:0 video data to 4:4:4 video data. Inverse quantization unit 306 may be configured to perform an inverse quantization on color space values. For example, inverse quantization unit 306 may be configured to convert 8 or 10 bit values of Y, Cb, and Cr to 12 bit values. Color space conversion unit 308 may be configured to convert video data in one color space format to video data in another color space format. For example, color space conversion unit may be configured to convert video data in an YCbCr color space format to video data in a RGB color space format according to a defined set of conversion equations. Electro-optical transfer function unit 310 may be configured to receive video data and transform the video data according to an EOTF. It should be noted that in some examples video data may be scaled to a range of 0 to 1 prior to the application of an EOTF. In one example, electro-optical transfer function unit 310 may be configured to transform video data according to the SMPTE ST 2084 transfer function described above.

Referring again to FIG. 1, display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. In one example, display 126 may include a video rendering device capable of supporting HDR video data (e.g., a device having a dynamic range of 0-10,000 cd/m²).

As described above, techniques in a video coding standard, such as, deblock filtering, sample adaptive offset (SAO) filtering, quantization parameter derivation, interpolation, and initialization of unavailable samples may not perform optimally if a range of sample values does not occupy an expected range of code words (e.g., if SDR video data is quantized according to SMPTE ST 2084). In addition to or as an alternative to using remapping techniques, such as the example remapping techniques described above, techniques described herein may enable a video coding device to mitigate the effects of range mapping errors during a coding process. For example, a video encoder and/or a video decoder may be configured to determine a utilized range of sample values for a particular bit depth. A utilized range of sample values may be based on an combination of component sample values, for example, one or all of Y, Cb, Cr and/or one or all of R, G, B, or another color sample format (e.g., subtractive CMYK) For example, a video coding device may be configured to determine a utilized range of sample values based on a minimum and maximum sample values for a particular set of samples. For example, a video coder may be configured to determine that no sample values within a sequence have a value greater than 520. Further, in some example, a utilized range sample values may be signaled. For example, a video encoder may be configured to signal a utilized range of sample values in a bitstream and/or as an out of band signal. One or more coding parameters may be based on a utilized range of sample values. For example, quantization parameter (QP) values, which may be based on bit depth, and values derived from QP values may be modified based a utilized range of sample values.

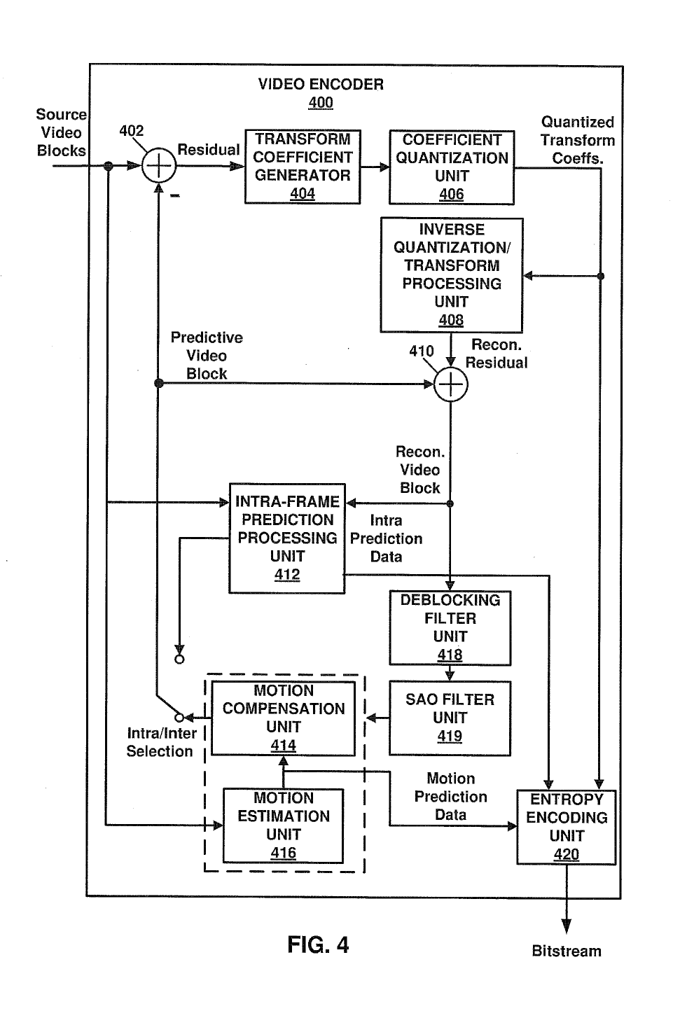

FIG. 4 is a block diagram illustrating an example of video encoder 400 that may implement the techniques for encoding video data described herein. It should be noted that although example video encoder 400 is illustrated as having distinct functional blocks, such an illustration is for descriptive purposes and does not limit video encoder 400 and/or sub-components thereof to a particular hardware or software architecture. Functions of video encoder 400 may be realized using any combination of hardware, firmware and/or software implementations. In one example, video encoder 400 may be configured to receive video data stored within a BT.2020/ST-2084 container, determine a utilized range of values for the video data, and determine one or more coding parameters based on the utilized range of values for the video data.

Video encoder 400 may perform intra-prediction coding and inter-prediction coding of video blocks within video slices, and, as such, may be referred to as a hybrid video encoder. In the example illustrated in FIG. 4, video encoder 400 receives source video blocks that have been divided according to a coding structure. For example, source video data may include macroblocks, CTUs, sub-divisions thereof, and/or another equivalent coding unit. In some examples, video encoder may be configured to perform additional sub-divisions of source video blocks. It should be noted that the techniques described herein are generally applicable to video coding, regardless of how source video data is partitioned prior to and/or during encoding. In the example illustrated in FIG. 4, video encoder 400 includes summer 402, transform coefficient generator 404, coefficient quantization unit 406, inverse quantization/transform processing unit 408, summer 410, intra-frame prediction processing unit 412, motion compensation unit 414, motion estimation unit 416, deblocking filter unit 418, sample adaptive offset (SAO) filter unit 419, and entropy encoding unit 420. As illustrated in FIG. 4, video encoder 400 receives source video blocks and outputs a bitstream.

In the example illustrated in FIG. 4, video encoder 400 may generate residual data by subtracting a predictive video block from a source video block. The selection of a predictive video block is described in detail below. Summer 402 represents a component configured to perform this subtraction operation. In one example, the subtraction of video blocks occurs in the pixel domain. Transform coefficient generator 404 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 404 may output residual transform coefficients to coefficient quantization unit 406.

Coefficient quantization unit 406 may be configured to perform quantization of the transform coefficients. The quantization process may reduce the bit depth associated with some or all of the coefficients. The degree of quantization may alter the rate-distortion (i.e., bit-rate vs. quality of video) of encoded video data. The degree of quantization may be modified by adjusting quantization parameters. A quantization parameter may be based on a predictive quantization parameter value and quantization parameter delta value. In ITU-T H.265, quantization parameters may be updated for each CU and a quantization parameter may be derived for each of luma (Y) and chroma (Cb and Cr) components.

In an example a modified quantization parameter may be derived based on dynamic range of input values, an input bit depth, such as, the luma and/or chroma bit depth. The modified quantization parameter may be used in the scaling (inverse quantization) process for transform coefficients. The modified quantization parameter may be used in the process mapping received set of binary symbols to a value. The modified quantization parameter may be used in the scaling (inverse quantization) process for quantized sample values. In an example the derivation of a modified quantization parameter may be based on value of a first syntax element received in the bitstream. The first syntax element may be conditionally received in the bitstream based on the value of a second syntax element received earlier in the bitstream.

In ITU-T H.265, for a current luma coding block in a coding unit, a luma quantization parameter, Qp′_{Y}, may be derived based on a predictive quantization parameter value and a quantization parameter delta value derived according to the following equations:

Qp′_{Y}=Qp_{Y}+QpBdOffset_{Y} EQUATION 1

Qp_{Y}=((qP_{Y}_{_}_{PRED}+CuQpDeltaVal+52+2*QpBdOffset_{Y})%(52+QpBdOffset_{Y}))−QpBdOffset_{Y} EQUATION 2
where
   QpBdOffset_{Y} is the quantization parameter range offset and is derived by QpBdOffset_{Y}=6*bit_depth_luma_minus8;
   bit_depth_luma_minus8 is equal to the bit depth of luma (bitDepthY) minus 8; qP_{Y}_{_}_{PRED} is equal to:
      a slice luma quantization parameter derived from variables signaled in a slice segment header, or
      the luma quantization parameter of the last coding unit in the previous quantization group in decoding order;
CuQpDeltaVal is derived from variables signaled in transform unit syntax and has a value in the inclusive range of −(26+QpBdOffset_{Y}/2) to +(25+QpBdOffset_{Y}/2); and
% is a modulus arithmetic operator, where x % y is remainder of x divided by y, defined only for integers x and y with x>=0 and y>0;

It should be noted that, in some examples, with respect to Equation 1 and Equation 2, QpBdOffset_{Y} may be generalized as including any value based on the bit depth of a luma component and Equation 2 may be generalized to include any function based on a luma quantization parameter predictor value, a coding unit quantization parameter delta value, and the bit depth of a luma component. Further, it should be noted that a luma quantization parameter predictor value may be signaled in a slice header, a sequence parameter set (SPS), a picture parameter set (PPS), or any other suitable location. In this manner, the techniques described herein should not be construed as being limited based on the illustrative examples described with respect to ITU-T H.265 and may be generally applicable to quantization parameters as defined in other video coding standards, including video coding standards currently under development.

Further, in ITU-T H.265, chroma quantization parameters, Qp′_{Cb} and Qp′_{Cr}, for a coding unit are derived according to the following equations:

Qp′_{Cb}=qP_{Cb}+QpBdOffset_{C} EQUATION 3

Qp′_{Cr}=qP_{Cr}+QpBdOffset_{C} EQUATION 4
where
   QpBdOffset_{C} is the quantization parameter range offset and is derived by QpBdOffset_{C}=6*bit_depth_chroma_minus8;
   bit_depth_chroma_minus8 is equal to the bit depth of chroma (bitDepthC) minus 8;

In ITU-T H.265, the variables qP_{Cb} and qP_{Cr} are set equal to a value of Qp_{C} as specified in Table 2 based on the index qPᵢ equal to variables qPi_{Cb} and qPi_{Cr}.

TABLE 2

| | | | | | | | | | | | | | | | | |
|---|---|---|---|---|---|---|---|---|---|---|---|---|---|---|---|---|
| qPi | <30 | 30 | 31 | 32 | 33 | 34 | 35 | 36 | 37 | 38 | 39 | 40 | 41 | 42 | 43 | >43 |
| Qp_{C} | = qPi | 29 | 30 | 31 | 32 | 33 | 33 | 34 | 34 | 35 | 35 | 36 | 36 | 37 | 37 | = qP-6 |

where qPi_{Cb} and qPi_{Cr} are derived as follows:

qPi_{Cb}=Clip3(−QpBdOffset_{C},57,Qp_{Y}+pps_cb_qp_offset+slice_cb_qp_offset) EQUATION 5

qPi_{Cr}=Clip3(−QpBdOffset_{C},57,Qp_{Y}+pps_cr_qp_offset+slice_cr_qp_offset) EQUATION 5
where
   Clip3(x,y,z) equals x, if z<x; equals y, if z>y; or equals z otherwise;
   pps_cb_qp_offset is signalled in the picture parameter set and has a value in the inclusive range of −12 to +12
   pps_cr_qp_offset is signalled in the picture parameter set and has a value in the inclusive range of −12 to +12
   slice_cb_qp_offset is signalled in the slice segment header and specifies a difference to be added to pps_cb_qp_offset and has a value in the inclusive range of −12 to +12;
   slice_cr_qp_offset is signalled in the slice segment header and specifies a difference to be added to pps_cr_qp_offset and has a value in the inclusive range of −12 to +12;

It should be noted that, in some examples, with respect to Equations 3-6 QpBdOffsetC may be generalized as any value based on the bit depth of a chroma component and functions for qPi_{Cb} and qPi_{Cr} may be generalized to include any function based on a luma quantization parameter (or variables associated therewith) and the bit depth of a chroma component. In this manner, the techniques described herein should not be construed as being limited based on the illustrative examples described with respect to ITU-T H.265 and may be generally applicable to chroma quantization parameters as defined in other video coding standards, including video coding standards currently under development. It should be noted that quantization parameters (or variables associated therewith) may be used to determine other values associated with video coding (e.g., de-blocking filter values, etc.). As such, the quantization parameters determined according to the techniques described herein may be used for other functions performed by a video encoder and/or a video decoder.

As described above, one region of a frame of video data may have a relatively smaller dynamic range (e.g., a portion of a scene in shadow) than another region of a frame. In some examples, these regions may be included with the same slice of video data. As illustrated in the equations above, in ITU-T H.265, for a block of video data the luma quantization parameter, Qp′_{Y} is derived independent of the luminance sample values for the block. That is, Qp′_{Y} as derived in ITU-T H.265 may not account for the actual luminance values for samples within a region of video data and/or luminance variations of regions of video within a frame. This may result in less than ideal coding performance. The example techniques described herein may be used to determine quantization parameters for a region of video data based on sample values with the region of video data.

In one example, video encoder 400 may be configured to determine a quantization parameter for a block of video data based at least in part on luminance values of samples within a block of video data. For example, video encoder 400 may be configured to determine a quantization parameter for a block of video data based at least in part on the average luminance value of samples within the block of video data. For example, for a CU, video encoder 400 may determine an average luma component value for all samples included in the CU and generate a luma and/or a chroma quantization parameter for the CU based on the average luma component value. Further, it should be noted that in some examples, a block of video data used to determine an average luminance value does not necessarily need to be the same block as the block of video data for which a quantization parameter is determined. For example, an average luminance value may be determined based on one or more CTU within a slice and one or more CUs within a CTU. These average luminance values may be used to generate a luma and/or a chroma quantization parameter for any CUs within a slice. In some examples, a block of video data used to determine an average luminance value may be aligned with CU, LCU, or PU block boundaries. In other examples, a block of video data used to determine an average luminance value is not necessarily aligned with a CU, LCU, or PU boundary.

In one example, the quantization parameter for a CU may be determined as a function of a scaling factor (e.g., A), multiplied by an average luminance value for a block of video data, (e.g., LumaAverage), plus an offset value (e.g., Offset). That is, a quantization parameter may be based on the following function:

A*LumaAverage+Offset.

In one example, the term A*LumaAverage+Offset may be referred to a quantization delta value. In one example, A*LumaAverage+Offset may be added to a predictor quantization parameter value (e.g., a slice QP value or a CTU QP value) to derive a quantization parameter value for a CU. Referring again to Equations 1 and 2 above, the term qP_{Y}_{_}_{PRED}+CuQpDeltaVal may be used to determine a luma component quantization parameter for a CU. In one example, video encoder 400 may be configured such that CuQpDeltaVal is based on A*LumaAverage+Offset. In an example, video encoder 400 may be configured such that qP_{Y}_{_}_{PRED} is equal to a pre-defined constant for every CU in a slice. In an example, the pre-defined constant is a slice luma quantization parameter that corresponds to variables signaled in a slice segment header.

It should be noted that in one example, the quantization parameter for a CU may be determined based on the following function including A, LumaAverage, and Offset:

max(A*LumaAverage+Offset,Constant)
where
   max(x,y) returns x, if x is greater than or equal to y, and returns y, if y is greater than x.

The term max(A*LumaAverage+Offset, Constant) may be used to determine a quantization parameter in a similar manner to the term A*LumaAverage+Offset. In one example, the value of A may be within the range of 0.01 to 0.05 and in one example may be equal to 0.03; the value of Offset may be within the range of −1 to −6 and in one example may be equal to −3; and the value of Constant may be within the range of −1 to 1 and in one example may be equal to 0. It should be noted that the values of A, Offset, and Constant may be based on observed coding performance for video data stored in the BT.2020/ST-2084 container. In one example, it may be desirable to set A, Offset, and Constant to values that achieve a coding performance for video data stored in a BT.2020/ST-2084 container comparable to coding the same data stored in a BT.709/BT.1886 container with a constant quantization parameter. It should be noted that the techniques described herein may be used to code video data stored in a BT.2020/ST-2084 container without requiring the input of video data in a BT.709/BT.1886 container. A video coding standard may specify one of a plurality of available color spaces and/or dynamic ranges. For example, HEVC includes video usability information (VUI) which may be used to signal color spaces, dynamic ranges, and other video data properties. In one example, functions used to derive a quantization parameter and associated parameters (e.g., A, Offset, and Constant) may be determined based on video usability information or similar information included in video coding standards under development. For example, functions may include other function based on luminance value statistics including for example, the maximum, the minimum, and/or the median luminance value for a block of video data.

As described above, in one example, a predictor quantization parameter value may be signaled in a bitstream at a slice header, a sequence parameter set, a picture parameter set, or any other suitable location. Further, in one example, a quantization parameter delta value may be determined based on a lookup table operation. For example, LumaAverage may reference a lookup table entry. Further, in one example, a quantization delta value may be determined based on other types of functions, including for example, a quadratic, a cubic, a polynomial, and/or a non-linear function. In this manner video encoder 400 represents an example of a device configured to receive an array of sample values corresponding to a component of video data, determine an average value for the array of sample values, and determine a quantization parameter for an array of transform coefficients based at least in part on the average value.

Referring again to Equation 5 and Equation 6 above, in Equation 5 and Equation 6 qPi_{Cb} and qPi_{Cr} are derived based on Qp_{Y}. In the example where luma component quantization parameter is based at least in part on an average luminance value for a block of video data it may be useful to modify how qPi_{Cb} and qPi_{Cr} are derived. That is, for example, it may be useful to use a dynamic range offset value to derive qPi_{Cb} and qPi_{Cr}. Further, the relationship between chroma quantization parameter and luma quantization parameter shown in Table 2 is not linear. Therefore, chroma quantization parameter derivation based on luma quantization parameter, as described above, may not perform optimally if a range of sample values does not occupy an expected range of code words. This may result in imbalanced rate allocation between luma and chroma. To mitigate this problem, In one example, video encoder 400 may be configured to derive qPi_{Cb} and qPi_{Cr} as follows:

qPi_{Cb}=Clip3(−QpBdOffset_{C},57,Qp_{Y}+dynamic_range_qp_offset+pps_cb_qp_offset+slice_cb_qp_offset)−dynamic_range_qp_offset; EQUATION 7

qPi_{Cr}=Clip3(−QpBdOffset_{C},57,Qp_{Y}+dynamic_range_qp_offset+pps_cr_qp_offset+slice_cr_qp_offset)−dynamic_range_qp_offset; EQUATION 8

In one example, dynamic_range_qp_offset is an example of a dynamic range offset value and may be defined as follows:
dynamic_range_qp_offset specify offsets to the luma quantization parameter Qp′y used for deriving Qp′_{Cb} and QP′_{Cr}. In one example, the values of dynamic_range_qp_offset shall be in the range of −12 to +12, inclusive.

By deriving qPi_{Cb} and qPi_{Cr} based on the variable dynamic_range_qp_offset, the chroma quanitzation parameters may be adjusted to mitigate range mapping errors. In one example, dynamic_range_qp_offset may be dependent on a dynamic range of input values, an input bit depth, such as, the luma and/or chroma bit depth. Further, dynamic_range_qp_offset may be derived from information in a bitstream, and/or may be signalled in slice header or PPS or SPS. Table 3 provides an example of syntax that may be used to signal dynamic_range_qp_offset in either a PPS or SPS.

TABLE 3

| | Descriptor |
|---|---|
| pic_parameter_set_rbsp( ) | |
| OR | |
| seq_parameter_set_rbsp( ) { | |
| ... | |
| If (dynamic_range_qp_offset_enabled_flag) | u (1) |

| | |
|---|---|
| dynamic_range_qp_offset | se (v) |

...

In one example, dynamic_range_qp_offset_enabled_flag may be defined as follows:
dynamic_range_qp_offset_enabled_flag equal to 1 specifies that the dynamic_range_qp_offset syntax element is present in the PPS [or SPS] and that dynamic_range_qp_offset may be present in the transform unit syntax. dynamic_range_qp_offset_enabled_flag equal to 0 specifies that the dynamic_range_qp_offset syntax element is not present in the PPS [or SPS] and that dynamic_range_qp_offset is not present in the transform unit syntax.

It should be noted that in other examples dynamic_range_qp_offset can be replaced by a dynamic range offset for each chroma component, e.g., dynamic_range_cb_qp_offset and dynamic_range_cr_qp_offset. Further, in one example dynamic_range_qp_offset may vary on a CU basis. Further, in one example dynamic_range_qp_offset may be inferred by a video decoder (e.g., based on the value of a quantization parameter delta value). In one example, the dynamic_range_qp_offset may be inferred as a function of the quantization parameter of the coding unit and/or the initial quantization parameter of the slice (i.e., the slice luma quantization parameter). For example, the dynamic_range_qp_offset may be equal to (the coding unit quantization parameter) minus (the initial slice quantization parameter). In one example, the dynamic range offset value may be inferred as a function of the average luma value of the coding unit and/or the initial quantization parameter of the slice. In one example, the initial quantization parameter of a slice may include qP_{Y}_{_}_{PRED}. As described in detail below, with respect to video decoder 300, quantization parameter delta values may be inferred. It should be noted that in some examples a dynamic range offset value may be inferred using similar techniques. For example, a dynamic range offset value may be determined by video decoder 300 based on an average luminance value of a decoded video block. In this manner video encoder 200 represents an example of a device configured to receive an array of sample values corresponding to a luma component of video data, determine an average value for the array of sample values, determine a luma quantization parameter for an array of transform coefficients based at least in part on the average value, and determine a chroma quantization parameter based on the quantization parameter.

Referring again to FIG. 4, quantized transform coefficients are output to inverse quantization/transform processing unit 408. Inverse quantization/transform processing unit 408 may be configured to apply an inverse quantization and an inverse transformation to generate reconstructed residual data. As illustrated in FIG. 4, at summer 410, reconstructed residual data may be added to a predictive video block. In this manner, an encoded video block may be reconstructed and the resulting reconstructed video block may be used to evaluate the encoding quality for a given prediction, transformation, and/or quantization. Video encoder 400 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra-prediction. Intra-frame prediction processing unit 412 may be configured to select an intra-frame prediction for a video block to be coded. Intra-frame prediction processing unit 412 may be configured to evaluate a frame and determine an intra-prediction mode to use to encode a current block. As described above, possible intra-prediction modes may include a planar prediction mode, a DC prediction mode, and angular prediction modes. Further, it should be noted that in some examples, a prediction mode for a chroma component may be inferred from an intra-prediction mode for a luma prediction mode. Intra-frame prediction processing unit 412 may select an intra-frame prediction mode after performing one or more coding passes. Further, in one example, intra-frame prediction processing unit 412 may select a prediction mode based on a rate-distortion analysis.

In HEVC, intra sample prediction may use neighboring above and left sample values as reference sample values to predict a current block. When neighboring sample values are not available, they may be substituted with other available sample values, and if none of these values are available, they may be initialized to a default value. In one example, a default value is provided as:

1<<(bitDepth−1)
where
   x<<y is an arithmetic left shift of a two's complement integer representation of x by y binary digits. This function is defined only for non-negative integer values of y. Bits shifted into the least significant bits (LSBs) as a result of the left shift have a value equal to 0; and
   bitDepth is bitDepthY for Luma and bitDepthC for Chroma.

Thus, when neighboring sample values are not available and sample values to be substituted are not available, the initialization value for reference sample values is (approximately) the mid-point of sample values at the full bit depth. For example, for 10-bit data (i.e., sample value range 0-1023), the initialization value is 512 and for 8-bit data (i.e., sample value range 0-255), the initialization value is 128. It should be noted that the default initialization may also apply to unavailable pictures. As described above, for example, with respect to Table 1, in some cases minimum and maximum pixel values may not occupy the full range 0 to (1<<bitDepth)−1 (e.g., the max value of SDR video data (e.g., 100 cd/m²) may be quantized as 520 for 10-bit data). In this case, data may not be centered around the mid-point of sample values at the full bit depth. In this case, initializing the unavailable reference samples to 1<<(bitDepth−1) may result in poor prediction, and lower coding performance.

In an example the derivation of unavailable reference sample values may be based dynamic range of the input data and/or an actual bit depth of the input sample values (e.g., based on actual sample values within a set of samples). In an example the derivation of unavailable reference sample values may be based on value of a first syntax element received in the bitstream. The first syntax element may be conditionally received in the bitstream based on the value of a second syntax element received earlier in the bitstream.

In one example, video encoder 400 may be configured to use a default initialization value other than the mid-point for unavailable reference samples. In one example, the initialization value may be related to the dynamic range of the input data and/or an actual bit depth of the input sample values (e.g., based on actual sample values within a set of samples). Further, in one example, an initialization value may be signaled in the bitstream (where signaled values may be received by a video decoder), or another value may be signaled in the bitstream and used to derive an initialization value. For example, an index to a value within a table may be used to derive an initialization value. In one example, the table may be derived based on observed data or may be pre-determined.

In one example, an initialization value may be signalled according to the example syntax provide in Table 4.

TABLE 4

| | Descriptor |
|---|---|
| pic_parameter_set_rbsp( ) | |
| OR | |
| seq_parameter_set_rbsp( ) { | |
| ... | |
| If (specify_default_padding_enabled_flag) | u (1) |

| | |
|---|---|
| default_padding_abs | ue (v) |

...

In one example, default_padding_abs may be defined as follows:
default_padding_abs specify a default padding value for unavailable samples other than the midpoint of samples values at the full bit depth.
specify_default_padding_enabled_flag equal to 1 specifies that the default_padding_abs syntax element is present in the PPS [or SPS].

Referring again to FIG. 4, motion compensation unit 414 and motion estimation unit 416 may be configured to perform inter-prediction coding for a current video block. It should be noted, that although illustrated as distinct, motion compensation unit 414 and motion estimation unit 416 may be highly integrated. Motion estimation unit 416 may be configured receive source video blocks and calculate a motion vector for PUs of a video block. A motion vector may indicate the displacement of a PU of a video block within a current video frame relative to a predictive block within a reference frame. Inter-prediction coding may use one or more reference frames. Further, motion prediction may be uni-predictive (use one motion vector) or bi-predictive (use two motion vectors). Motion estimation unit 416 may be configured to select a predictive block by calculating a pixel difference determined by, for example, sum of absolute difference (SAD), sum of square difference (SSD), or other difference metrics.

As described above, a motion vector may be determined and specified according to motion vector prediction. Motion estimation unit 416 may be configured to perform motion vector prediction, as described above, as well as other so-called Advance Motion Vector Predictions (AMVP). For example, motion estimation unit 416 may be configured to perform temporal motion vector prediction (TMVP), support “merge” mode, and support “skip” and “direct” motion inference. For example, temporal motion vector prediction (TMVP) may include inheriting a motion vector from a previous frame.

As illustrated in FIG. 4, motion estimation unit 416 may output motion prediction data for a calculated motion vector to motion compensation unit 414 and entropy encoding unit 420. Motion compensation unit 414 may be configured to receive motion prediction data and generate a predictive block using the motion prediction data. For example, upon receiving a motion vector from motion estimation unit 416 for the PU of the current video block, motion compensation unit 414 may locate the corresponding predictive video block within a frame buffer (not shown in FIG. 4). It should be noted that in some examples, motion estimation unit 416 performs motion estimation relative to luma components, and motion compensation unit 414 uses motion vectors calculated based on the luma components for both chroma components and luma components. It should be noted that motion compensation unit 414 may further be configured to apply one or more interpolation filters to a reconstructed residual block to calculate sub-integer pixel values for use in motion estimation.

As illustrated in FIG. 4, motion compensation unit 414 and motion estimation unit 416 may receive reconstructed video block via deblocking filter unit 418 and SAO filtering unit 419. Deblocking filter unit 418 may be configured to perform deblocking techniques. Deblocking refers to the process of smoothing the boundaries of reconstructed video blocks (e.g., make boundaries less perceptible to a viewer). SAO filtering unit 419 may be configured to perform SAO filtering. SAO filtering is a non-linear amplitude mapping that may be used to improve reconstruction by adding an offset to reconstructed video data. SAO filtering is typically applied after applying de-blocking.

In an example a decision process outputs deblocking decisions and parameters used for the filtering process used in deblocking. The decision process may be based on based dynamic range of the input data and/or an actual bit depth of the input sample values (e.g., based on actual sample values within a set of samples). In an example the decision process may be based on the value of a first syntax element received in the bitstream. The first syntax element may be conditionally received in the bitstream based on the value of a second syntax element received earlier in the bitstream.

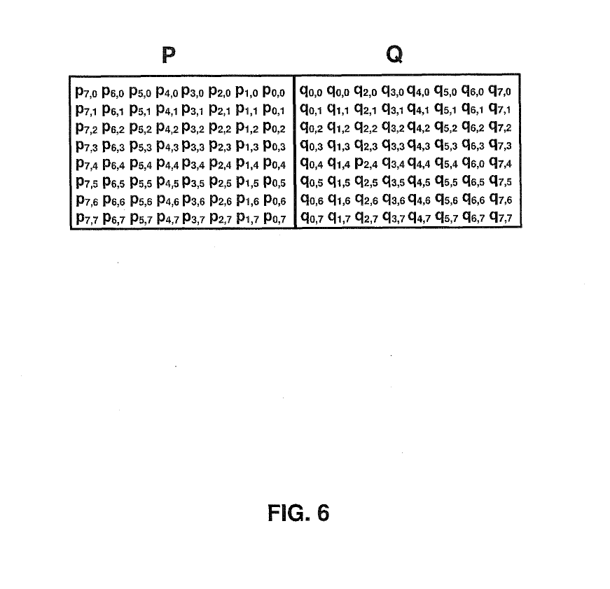

In HEVC, a deblocking filter may be applied to samples adjacent to a boundary of neighboring video blocks, such as, a PU boundary (PB) or a TU boundary (TB). In HEVC, the deblocking filter granularity is 8×8 or higher. FIG. 6 is a conceptual diagram illustrating two 8×8 neighboring video blocks, P and Q. The decision to apply a deblocking filter to a boundary is based on a boundary filter strength, bS, where bS may have a value of 0, 1, or 2 based on predictions associated with P and Q (e.g., if one of P or Q uses an intra-prediction mode, bS equals two). Further, a determination of a filter type (e.g., none, strong, or weak) to apply to a boundary is based on comparing values of samples within blocks P and Q to defined thresholds, β and t_{C}. For example filtering decisions may be based on the following conditions:

|p_{2,0}−2p_{1,0}+p_{0,0}|+|p_{2,3}−2p_{1,3}+p_{0,3}|+|q_{2,0}−2q_{1,0}|+|q_{0,0}|+q_{2,3}−2q_{1,3}+q_{0,3}|>β

|p2,i−2p1,i+p0,i|+|q2,i−2q1,i+q0,i|<β/8

|p3,i−p0,i|+|q0,i−q3,i|<β/8

|p0,i−q0,i|<2.5t_{C}

In HEVC, for luma block edges, the variable β is derived as follows:

β=β′*(1<<(BitDepthy−8))
where
β′ is determined as specified in Table 5 based on a luma quantization parameter Q derived as follows:

Q=Clip3(0,51,qP_{L}+(slice_beta_offset_div2<<1))
where
   qP_{L}=((Qp_{Q}+Qp_{P}+1)>>1), the variables QpQ and QpP are set equal to the QpY values of the coding units which include the coding blocks containing the sample q0,0 and p0,0, respectively;
   slice_beta_offset_div2 is the value of the syntax element slice_beta_offset_div2 for the slice that contains sample q_{0,0}.

In HEVC, for luma block edges, the variable t_{C} is derived as follows:

t_{C}=t_{C}′*(1<<(BitDepthy−8))
where
t_{C}′ is determined as specified in Table 5 based on a luma quantization parameter Q derived as follows:

Q=Clip3(0,53,qP_{L}+2*(bS−1)+(slice_tc_offset_div2<<1))
where
   slice_tc_offset_div2 is the value of the syntax element slice_tc_offset_div2 for the slice that contains sample q_{0,0}.

In HEVC, for chroma block edges, the variable t_{C} is derived as follows:

t_{C}=t_{C}′*(1<<(BitDepth_{C}−8))
where
t_{C}′ is determined as specified in Table 5 based on a chroma quantization parameter Q derived as follows:

Q=Clip3(0,53,Qpc+2+(slice_tc_offset_div2<<1)),
the variables Qp_{C} and QpP are set equal to the Qp_{C} values of the coding units which include the coding blocks containing the sample q0,0 and p0,0, respectively
where
   slice_tc_offset_div2 is the value of the syntax element slice_tc_offset_div2 for the slice that contains sample q_{0,0}.
   Qp_{C} is determined as specified in Table 2 based on the index qPi derived as follows:

qPi=((Qp_{Q}+Qp_{P}+1)>>1)+cQpPicOffset
It should be noted that in some cases, Qp_{C} is equal to Min(qPi, 51)
   cQpPicOffset may respectively be set equal to pps_cb_qp_offset or pps_cr_qp_offset, described above.

TABLE 5
Derivation of threshold variables β′ and t_{C}′ from input Q

| | | | | | | | | | | | | | | | | | | | |
|---|---|---|---|---|---|---|---|---|---|---|---|---|---|---|---|---|---|---|---|
| Q | 0 | 1 | 2 | 3 | 4 | 5 | 6 | 7 | 8 | 9 | 10 | 11 | 12 | 13 | 14 | 15 | 16 | 17 | 18 |
| β′ | 0 | 0 | 0 | 0 | 0 | 0 | 0 | 0 | 0 | 0 | 0 | 0 | 0 | 0 | 0 | 0 | 6 | 7 | 8 |
| t_{C}′ | 0 | 0 | 0 | 0 | 0 | 0 | 0 | 0 | 0 | 0 | 0 | 0 | 0 | 0 | 0 | 0 | 0 | 0 | 1 |
| Q | 19 | 20 | 21 | 22 | 23 | 24 | 25 | 26 | 27 | 28 | 29 | 30 | 31 | 32 | 33 | 34 | 35 | 36 | 37 |
| β′ | 9 | 10 | 11 | 12 | 13 | 14 | 15 | 16 | 17 | 18 | 20 | 22 | 24 | 26 | 28 | 30 | 32 | 34 | 36 |
| t_{C}′ | 1 | 1 | 1 | 1 | 1 | 1 | 1 | 1 | 2 | 2 | 2 | 2 | 3 | 3 | 3 | 3 | 4 | 4 | 4 |
| Q | 38 | 39 | 40 | 41 | 42 | 43 | 44 | 45 | 46 | 47 | 48 | 49 | 50 | 51 | 52 | 53 | | | |
| β′ | 38 | 40 | 42 | 44 | 46 | 48 | 50 | 52 | 54 | 56 | 58 | 60 | 62 | 64 | — | — | | | |
| t_{C}′ | 5 | 5 | 6 | 6 | 7 | 8 | 9 | 10 | 11 | 13 | 14 | 16 | 18 | 20 | 22 | 24 | | | |

As described above, a deblocking filter may not perform optimally if a range of sample values does not occupy an expected range of code words. In one example, video encoder 400 may be configured to derive a β value as follows: β=β′*dynamic_range_scale
where
β′ is determined as specified in Table 5 based on a luma quantization parameter Q derived as follows:

Q=Clip3(0,51,qP_{L}+dynamic_range_qp_offset+(slice_beta_offset_div2<<1))

In one example, video encoder 400 may be configured to derive t_{C} value as follows:

t_{C}=t_{C}′*dynamic_range_scale
where
t_{C}′ is determined as specified in Table 5 based on a chroma quantization parameter Q derived as follows:

Q=Clip3(0,53,qP_{L}+dynamic_range_qp_offset+2*(bS−1)+(slice_tc_offset_div2<<1))

In one example, video encoder 400 may be configured to derive t_{C} for chroma block edges as follows:

t_{C}=t_{C}′*dynamic_range_scale
where
t_{C}′ is determined as specified in Table 5 based on a chroma quantization parameter Q derived as follows:

Q=Clip3(0,53,Qpc+dynamic_range_qp_offset+2+(slice_tc_offset_div2<<1)),

In one example, dynamic_range_qp_offset may be dependent on dynamic range of input value, may be dependent on an input bit depth (e.g., bitDepthY or bitDepthC), may be derived from the given information from the bitstream, and/or may be signalled in slice header or PPS or SPS. An example of signalling dynamic_range_qp_offset is described above with respect to Table 3. Further, in one example, dynamic_range_scale may be derived from dynamic_range_qp_offset and a bit depth.

As described above, SAO filtering unit 419 may be configured to perform SAO filtering. As described above, quantization of transform coefficients results in a data loss between reconstructed and original blocks. The data loss is not typically uniformly distributed among pixels. Typically, there is a bias in distortion around edges. In addition to bias in quantization distortion around edges, systematic errors related to specific ranges of pixel values may also occur. Both of these type of systematic errors (or biases) may be corrected using SAO filtering. It should be noted that SAO filtering may optionally be turned off, applied only to luma samples, or applied only to chroma samples. HEVC defines two flags that enabling SAO filtered to be controlled, slice_sao_luma_flag (on/off for luma) and slice_sao_chroma_flag (on/off for chroma). Further, SAO parameters can be either explicitly signaled in a CTU header or inherited from a left or above CTU. A SAO may be adaptively applied on pixels. HEVC provides two types of SAO filters (1) an edge type SAO filter, where an offset depends on edge mode. Use of an edge type may be signalled in HEVC by a syntax element SaoTypeldx (e.g., equalling 2); and (2) a band type SAO filter, where an offset depends on a sample amplitude. Use of a band type SAO filter may be signalled in HEVC by a syntax element SaoTypeldx (e.g., equalling 1). A band type SAO filter is typically beneficial in noisy sequences or in sequences with large gradients.

A band type SAO filter may classify pixels into different bands based on their intensity. In one example, the pixel range from 0 to 2^{N}−1 (e.g., 0 to 255 for N=8) may be uniformly segmented into 32 bands. Samples having a value within four consecutive bands may be modified by adding values denoted as a band offset. Band offsets may be signaled in a CTU header.

As described above, an SAO filter may not perform optimally if a range of sample values does not occupy an expected range of code words. In one example, video encoder 400 may be configured to determine a utilized range of sample values and the utilized range of sample values may be used for SAO filtering. In one example, a utilized range of sample values may be uniformly split into 32 bands and the sample values belonging to four consecutive bands may be modified by adding the values denoted as band offsets. Further, in one example, information associated with a utilized range may be signaled in slice or sequence or picture parameter header. In one example, an SAO band offset control technique may be controlled by a flag(s) included at that SPS, PPS, Slice, CTU, CU, and/or PU level.

Table 6 provides an example syntax that may be used to signal an SAO technique in either a PPS or SPS.

TABLE 6

| | Descriptor |
|---|---|
| pic_parameter_set_rbsp( ) | |
| OR | |
| seq_parameter_set_rbsp( ) { | |
| ... | |
| If (dynamic_range_SAO_enabled_flag) | u (1) |

| | |
|---|---|
| dynamic_range_SAO_MAX | se (v) |

...

In one example dynamic_range_SAO_enabled_flag and dynamic_range_SAO_MAX may be defined as follows:
dynamic_range_SAO_enabled_flag equal to 1 specifies that the dynamic_range_SAO_MAX syntax element is present in the PPS [or SPS] and that dynamic_range_SAO_MAX may be present in the slice unit syntax or CTU syntax. dynamic_range_qp_offset_enabled_flag equal to 0 specifies that the dynamic_range_qp_offset syntax element is not present in the PPS [SPS] and that dynamic_range_qp_offset is not present in the transform unit syntax.
dynamic_range_SAO_MAX specify the maximum pixel values which is being considered in band offset mode in SAO. Specifically, the sample value range from 0 to dynamic_range_SAO_MAX is equally divided into 32 bands in Band Offset mode.

Referring again to FIG. 4, entropy encoding unit 420 receives quantized transform coefficients and predictive syntax data (i.e., intra-prediction data and motion prediction data). It should be noted that in some examples, coefficient quantization unit 406 may perform a scan of a matrix including quantized transform coefficients before the coefficients are output to entropy encoding unit 420. In other examples, entropy encoding unit 420 may perform a scan. Entropy encoding unit 420 may be configured to perform entropy encoding according to one or more of the techniques described herein. Entropy encoding unit 420 may be configured to output a compliant bitstream, i.e., a bitstream that a video decoder can receive and reproduce video data therefrom.

As described above, syntax elements may be entropy coded according to an entropy encoding technique. To apply CABAC coding to a syntax element, a video encoder may perform binarization on a syntax element. Binarization refers to the process of converting a syntax value into a series of one or more bits. These bits may be referred to as “bins.” For example, binarization may include representing the integer value of 5 as 00000101 using an 8-bit fixed length technique or as 11110 using a unary coding technique. Binarization is a lossless process and may include one or a combination of the following coding techniques: fixed length coding, unary coding, truncated unary coding, truncated Rice coding, Golomb coding, k-th order exponential Golomb coding, and Golomb-Rice coding. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265. In some examples, the techniques described herein may be generally applicable to bin values generated using any binarization coding technique.

After binarization, a CABAC entropy encoder may select a context model. For a particular bin, a context model may be selected from a set of available context models associated with the bin. It should be noted that in ITU-T H.265, a context model may be selected based on a previous bin and/or syntax element. A context model may identify the probability of a bin being a particular value. For instance, a context model may indicate a 0.7 probability of coding a 0-valued bin and a 0.3 probability of coding a 1-valued bin. After selecting an available context model, a CABAC entropy encoder may arithmetically code a bin based on the identified context model.

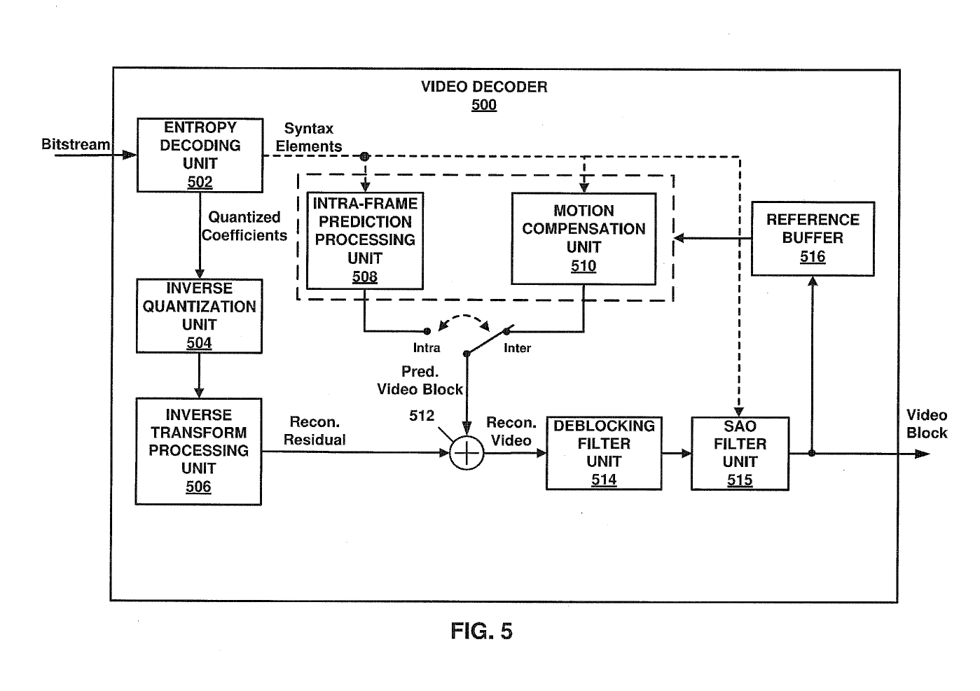

FIG. 5 is a block diagram illustrating an example of a video decoder that may be configured to decode video data according to one or more techniques of this disclosure. In one example, video decoder 500 may be configured to receive video data, determine a utilized range of values for the video data, and determine one or more coding parameters based on the utilized range of values for the video data. In another example, video decoder 500 may be configured to receive an array of sample values corresponding to a component of video data, determine an average value for the array of sample values, and determine a quantization parameter for an array of transform coefficients based at least in part on the average value.

Video decoder 500 may be configured to perform intra-prediction decoding and inter-prediction decoding and, as such, may be referred to as a hybrid decoder. In the example illustrated in FIG. 5 video decoder 500 includes an entropy decoding unit 502, inverse quantization unit 504, inverse transform processing unit 506, intra-frame prediction processing unit 508, motion compensation unit 510, summer 512, de-blocking filter unit 514, SAO filter unit 515, and reference buffer 516. Video decoder 500 may be configured to decode video data in a manner consistent with a video coding standard, including video coding standards currently under development. Video decoder 500 may be configured to receive a bitstream, including variables signaled therein, as described above. It should be noted that although example video decoder 500 is illustrated as having distinct functional blocks, such an illustration is for descriptive purposes and does not limit video decoder 500 and/or sub-components thereof to a particular hardware or software architecture. Functions of video decoder 500 may be realized using any combination of hardware, firmware and/or software implementations.

As illustrated in FIG. 5, entropy decoding unit 502 receives an entropy encoded bitstream. Entropy decoding unit 502 may be configured to decode quantized syntax elements and quantized coefficients from the bitstream according to a process reciprocal to an entropy encoding process. Entropy decoding unit 502 may be configured to perform entropy decoding according any of the entropy coding techniques described above. Entropy decoding unit 502 may parse an encoded bitstream in a manner consistent with a video coding standard.

As illustrated in FIG. 5, inverse quantization unit 504 receives quantized transform coefficients from entropy decoding unit 502. Inverse quantization unit 504 may be configured to apply an inverse quantization. Inverse transform processing unit 506 may be configured to perform an inverse transformation to generate reconstructed residual data. The techniques respectively performed by inverse quantization unit 504 and inverse transform processing unit 506 may be similar to techniques performed by inverse quantization/transform processing unit 408 described above. An inverse quantization process may include a conventional process, e.g., as defined by the H.265 decoding standard. Further, the inverse quantization process may also include use of a quantization parameter. Quantization parameters may be derived according to one or more of the techniques described above with respect to video encoder.

As described above, a video encoder may signal a predictive quantization parameter value and a delta quantization parameter (e.g., qP_{Y}_{_}_{PRED} and CuQpDeltaVal). In some examples, video decoder 500 may be configured to determine a predictive quantization parameter and/or a delta quantization parameter. That is, video decoder 500 may be configured to determine a predictive quantization parameter and/or a delta quantization parameter based on properties of decoded video data and infer a predictive quantization parameter and/or a delta quantization parameter based data included in a bitstream. It should be noted that in the examples, where video decoder 500 determines a predictive quantization parameter and/or a delta quantization parameter, encoded video data may be transmitted using a reduced bit-rate. That is, for example, a bit savings may occur when CuQpDeltaVal is not signaled or signaled less frequently.

In one example video decoder 500 may determine a delta quantization parameter based at least in part on the average luminance value of samples within a block of video data. A block of video data used to determine an average luminance value may include various types of blocks of video data. In one example, the average luma value may be calculated for a block of video data including a coding unit, largest coding unit, and/or prediction unit. In one example, the average luma value may be calculated for a block of video data including the output of an intra-prediction process. In one example, the average luma value may be calculated for a block of video data including the output of the inter-prediction process. In one example, the average luma value may be calculated for a block of video data including reconstructed pixel values outside the current block (e.g., a neighboring block). In one example, the reconstructed pixels outside the current block may correspond to reconstructed pixel values that are available for intra-prediction of the current block. In one example, the average luma value may be set equal to a pre-determined value if reconstructed pixels outside the current block are not available for intra-prediction.

Once video decoder 500 determines an average luma value for a block of video data, a delta quantization parameter may be determined in a manner similar to that described above. For example, the functions A*LumaAverage+Offset and max(A*LumaAverage+Offset, Constant) described above may be used. In one example, one or more of A, Offset, and Constant may be signaled in the bitstream. Further, in one example, the average luminance value may be used to reference a delta quantization parameter in a look-up table.

Further, in one example, a quantization parameter delta value determined by video decoder 500 may be used in conjunction with a quantization parameter delta value signaled in a bitstream to determine a quantization parameter. For example, CuQpDeltaVal described above, or a similar quantization parameter delta value may be determined by video decoder 500 based on a signaled quantization parameter delta value and an inferred quantization parameter delta value. For example, CuQpDeltaVal may be equal to CuQpDeltaValsignaled+CuQpDeltaValinferred where CuQpDeltaValsignaled is included in the bitstream and CuQpDeltaValinferred is determined according to one or more of the example techniques described above.

Further, it should be noted that in some examples, in additional to including qP_{Y}_{_}_{PRED} described above, a quantization parameter predictor value may include one or more different types of signaled and/or inferred quantization parameter predictor values. For example, a quantization parameter predictor value may be determined based on a previous coding unit. For example, a quantization parameter for a current coding unit may be based on the following example functions:

max(A*Luma_CurrentAverage+Offset,Constant)−max(A*Luma_PreviousAverage+Offset,Constant)+Previous_QP+delta_QP

or

A*(Luma_CurrentAverage-Luma_PreviousAverage)+Previous_QP+delta_QP.
where
   Luma_CurrentAverage and Luma_PreviousAverage are respective LumaAverage values for a current coding unit and a previous coding unit;
   delta_QP includes any of the example quantization parameter delta values described above; and
   Previous_QP is a quantization parameter associated with a previous coding unit.

Referring again to FIG. 5, inverse transform processing unit 506 may be configured to apply an inverse DCT, an inverse DST, an inverse integer transform, or a conceptually similar inverse transform process, to the transform coefficients in order to produce residual blocks in the pixel domain. As illustrated in FIG. 5, reconstructed residual data may be provided to summer 512. Summer 512 may add reconstructed residual data to a predictive video block and generate reconstructed video data. A predictive video block may be determined according to a predictive video technique (i.e., intra-frame prediction and inter-frame prediction).

Intra-frame prediction processing unit 508 may be configured to receive intra-frame prediction syntax elements and retrieve a predictive video block from reference buffer 516. Reference buffer 516 may include a memory device configured to store one or more frames of video data. Intra-frame prediction syntax elements may identify an intra-prediction mode, such as the intra-prediction modes described above. In one example, initialization values may be derived according to one or more of the techniques described above with respect to video encoder.

Motion compensation unit 510 may receive inter-prediction syntax elements and generate motion vectors to identify a prediction block in one or more reference frames stored in reference buffer 516. Motion compensation unit 510 may produce motion compensated blocks, possibly performing interpolation based on interpolation filters. Identifiers for interpolation filters to be used for motion estimation with sub-pixel precision may be included in the syntax elements. Motion compensation unit 510 may use interpolation filters to calculate interpolated values for sub-integer pixels of a reference block.

Deblocking filter unit 514 may be configured to perform filtering on reconstructed video data. For example, deblocking filter unit 514 may be configured to perform de-blocking, as described above with respect to deblocking filter unit 418. SAO filter unit 515 may be configured to perform filtering on reconstructed video data. For example, SAO filter unit 515 may be configured to perform SAO filtering, as described above with respect to SAO filter unit 419. As illustrated in FIG. 5, a video block may be output by video decoder 500. In this manner, video decoder 500 may be configured to generate reconstructed video data.

In an example the output of the decoder 124 may be modified (for e.g. clipped to lie within a range of values) based on based dynamic range of the input data and/or an actual bit depth of the input sample values (e.g., based on actual sample values within a set of samples). In an example the output of the decoder 124 may be modified (for e.g. clipped to lie within a range of values) based on the value of a first syntax element received in the bitstream. The first syntax element may be conditionally received in the bitstream based on the value of a second syntax element received earlier in the bitstream.

In an example the range of values allowed for transform coefficient level values carried within a conforming bitstream may be based on based dynamic range of the input data and/or an actual bit depth of the input sample values (e.g., based on actual sample values within a set of samples). In an example the range of values allowed for transform coefficient level values carried within a conforming bitstream may be based on the value of a first syntax element received in the bitstream. The first syntax element may be conditionally received in the bitstream based on the value of a second syntax element received earlier in the bitstream.

In an example the output of the inverse quantization unit 504 may be modified (for e.g. clipped to lie within a range of values) based on based dynamic range of the input data and/or an actual bit depth of the input sample values (e.g., based on actual sample values within a set of samples). In an example the output of the inverse quantization unit 504 may be modified (for e.g. clipped to lie within a range of values) based on the value of a first syntax element received in the bitstream. The first syntax element may be conditionally received in the bitstream based on the value of a second syntax element received earlier in the bitstream.

In an example the inverse transform processing unit 506 may comprise of two one-dimensional (1-D) inverse transform units. In an example the output of the first 1-D inverse transform unit within 506 may be modified (for e.g. clipped to lie within a range of values) based on based dynamic range of the input data and/or an actual bit depth of the input sample values (e.g., based on actual sample values within a set of samples). In an example of the first 1-D inverse transform unit within 506 may be modified (for e.g. clipped to lie within a range of values) based on the value of a first syntax element received in the bitstream. The first syntax element may be conditionally received in the bitstream based on the value of a second syntax element received earlier in the bitstream.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1-34. (canceled)

35. A method of determining a quantization parameter, the method comprising the steps of:
receiving an array of sample values corresponding to a component of video data;
determining an average value for the array of sample values; and
determining a quantization parameter for an array of transform coefficients based at least in part on the average value.

36. The method of claim 35, wherein the component includes a luma component.

37. The method of claim 35, wherein the array of sample values is aligned with the array of transform coefficient values.

38. The method of claim 35, wherein the array of sample values includes a different number of samples than the array of transform coefficient values.

39. The method of claim 35, wherein the array of sample values includes sample values derived from decoded video data.

40. The method of claim 35, wherein determining the quantization parameter based at least in part on the average value includes determining a quantization parameter delta value based at least in part on the average value.

41. The method of claim 40, wherein determining the quantization parameter delta value based at least in part on the average value includes applying a linear function to the average value.

42. The method of claim 40, wherein determining the quantization parameter delta value based at least in part on the average value includes determining a maximum of a linear function applied to the average value and a constant value.

43. The method claim 40, further comprising signaling the quantization parameter delta value in a bitstream.

44. The method of claim 40, wherein determining the quantization parameter for an array of transform coefficients based at least in part on the average value includes adding the quantization parameter delta value to a predictive quantization parameter.

45. The method of claim 44, wherein the predictive quantization parameter includes one of a predictive quantization parameter signaled in a slice header or a predictive quantization parameter determined based as least in part on a previous coding unit.

46. The method of claim 35, wherein the quantization parameter includes a luma quantization parameter and further comprising determining a chroma quantization parameter based on the quantization parameter.

47. The method of claim 46, where determining the chroma quantization parameter based on the quantization parameter includes determining the chroma quantization parameter based on a dynamic range offset value.

48. The method of claim 35, wherein the array of sample values includes sample values corresponding to a color space having a greater area than an ITU-R BT.709 color space.

49. The method of claim 48, wherein the array of sample values includes sample values corresponding to an ITU-R BT.2020 color space.

50-54. (canceled)
